(19) United States
(12) Patent Application Publication
(10) Pub. No.: US 2004/0141714 A1
(43) Pub. Date: Jul. 22, 2004

(54) Apparatus and method for processing a moving picture including a frame having information added thereto

(75) Inventors: Rieko Izume, Osaka (JP); Tsutomu Honda, Osaka (JP)

Correspondence Address: MCDERMOTT, WILL & EMERY, 600 13th Street, N.W., WASHINGTON, DC, 20005-3096, US

(73) Assignee: MINOLTA CO., LTD.

(21) Appl. No.: 10/404,053

(22) Filed: Apr. 2, 2003

(30) Foreign Application Priority Data
Jan. 17, 2003 (JP) 2003-009387

(51) Int. Cl. H04N 5/76; H04N 5/781

(52) U.S. Cl. 386/46; 386/125

(57) ABSTRACT

An apparatus for efficiently adding information in a particular region on part of the frames constituting a moving picture, an apparatus for conveniently selecting a moving picture having information added to part of the frames thereof, and an apparatus for flexibly playing back such a moving picture are provided. A plurality of frames included in a moving picture are displayed as thumbnail images in an arranged manner, and, for selected frames, a region thereon in which to add information is specified. When a moving picture to be played back is selected, frames from a plurality of moving picture files are displayed in an arranged manner, and, to moving pictures having information added to any of their frames, an image indicating the addition of information is added. A moving picture is played back either by playing back all of its frames without playing back information, by playing back only those frames to which information is added, or by playing back all of its frames and meanwhile repeatedly playing back those frames to which information is added together with the information.

This application is based on Japanese Patent Application No. 2003-9387 filed on Jan. 17, 2003, the contents of which are hereby incorporated by reference.

### BACKGROUND OF THE INVENTION

1. Field of the Invention

The present invention relates to a moving picture, and in particular to a moving picture of which part of the frames have information added thereto.

2. Description of the Prior Art

A movie, a typical example of a moving picture, is composed of a series of images (frames) and sound. When an individual shoots a moving picture with a video camera, he or she usually records sound, too. These moving pictures thus have information in the form of sound (hereinafter “sound information”), added to all of their frames. Moving pictures are produced for various purposes, some for entertainment purposes, such as movies publicly shown in cinemas, and others for educational purposes, such as those explaining various facts in the fields of science, fine arts, sports, etc. In moving pictures of the latter type, the sound information added to all of their frames function as explanations.

In recent years, it has been becoming quite common to play back and edit on a personal computer a moving picture shot with a video camera, and even produce a moving picture on a personal computer itself Personal computers permit information in the form of characters (hereinafter “character information”) to be added to a moving picture. Such character information displayed superimposed on images are also useful as explanations.

Japanese Patent Application Laid-Open No. 2000-69442 proposes adding information to part of the frames constituting a moving picture and adding information in a particular region on part of the frames constituting a moving picture. This technique can be applied to a moving picture produced for explanation purposes to permit information to be added in a particular region on particular frames. Thus, this technique is expected to help make clear which explanation corresponds to which part of a moving picture and thereby enhance the significance of adding information to the moving picture.

However, while the publication mentioned above discloses what information to add to frames included in a moving picture, it does not describe how to select frames to which to add information or how to specify a region on the frames to which to add information. A moving picture is generally composed of a large number of frames, and this necessitates an efficient method for selecting frames to which to add information.

The simplest and easiest way to play back a moving picture having information added thereto is to play it back from the first frame thereof and wait for the frames to which the information is added to be played back. By this way, however, the information is played back even when it need not be played back. Moreover, once the frames to which the information is added have been played back to the end, the information cannot be played back again unless the moving picture is played back from the first frame thereof again. Thus, a more flexible playback method is desired. It is also desirable that moving pictures having information added to part of their frames be clearly distinguished from those having no information added thereto, because this makes it easy to select which moving picture to play back and how to play it back.

### SUMMARY OF THE INVENTION

An object of the present invention is to provide a method for efficiently adding information in a particular region on part of the frames constituting a moving picture, a method for conveniently selecting a moving picture having information added to part of the frames thereof, and a method for flexibly playing back a moving picture having information added to part of the frames thereof.

To achieve the above object, according to one aspect of the present invention, an apparatus for processing a moving picture is provided with: a display for displaying, in an arranged manner, a plurality of frames included in a moving picture; a selector for selecting, according to a command from a user, part of the displayed frames; a setter for setting, according to a command from the user, a region on the selected frames; an input portion for receiving information input by the user; and a recorder for recording the set region and the input information in association with the selected frames.

This moving picture processing apparatus displays a plurality of frames from a moving picture, and lets the user select a frame, specify a region on the frame, and enter information to establish correspondence of the region, information, and frame to one another. In this way, the apparatus adds information in a region on part of the frames constituting the moving picture. Since a plurality of frames are displayed at a time, it is easy to grasp the relative positions of the frames in the moving picture. This makes selection easy, and helps reduce the time required for selection. By displaying the frames on a reduced scale, i.e., as so-called thumbnail images, it is possible to display many images at a time in an arranged manner.

It is possible to display either consecutive frames or frames located at intervals. When consecutive frames are displayed, the user can minutely observe how the contents of the moving picture go changing, and thus can accurately select, from among frames that only slightly differ from one another, the frame to which to add information. On the other hand, when frames located at intervals are displayed, the user can roughly grasp how the contents of the moving picture go changing, and thus can select the frame to which to add information quickly even if the moving picture includes a large number of frames and its contents change greatly.

When frames are displayed in an arranged manner on a reduced scale, a region may be specified on a reduced image itself, or on the corresponding original-size image displayed anew. Displaying the original-size image permits a region to be specified accurately.

Here, the display may display frames located at a predetermined time interval from one another. The predetermined time interval may be variable. This permits the user to specify the time interval between the displayed frames according to how the contents of the moving picture change and the total number of frames, and thus makes selection of a frame easier.

The shape of the region may be variable. This permits the user to add information in a region having a desired shape.

The selector may select, according to a command from the user, a plurality of frames. This permits information to be added to a plurality of frames at a time.

The setter may set, based on the region set on the selected frames, a region on all the frames located between the selected frames. The recorder may record the set-region and the input information in association with each of those frames. This makes it extremely easy to add information to a plurality of frames. Here, either a region is specified for one of the plurality of selected frames so that the so specified region is applied to all the frames in between, or a region is specified for each of the plurality of selected frames so that regions calculated by interpolating the so specified regions are applied to the intermediary frames located in between.

Information may be in the form of text, sound, or an image. The input portion is so configured as to be capable of handling the type of information actually used.

According to another aspect of the present invention, a method for processing a moving picture includes the steps of displaying, in an arranged manner, a plurality of frames included in a moving picture; selecting, according to a command from a user, part of the displayed frames; setting, according to a command from the user, a region on the selected frames; receiving information input by the user; and recording the set region and the input information in association with the selected frames.

By adopting this method, it is possible to easily realize the moving picture processing apparatus described above. For that purpose, it is advisable to record the steps described above in the form of a program to be run on a computer.

According to another aspect of the present invention, an apparatus for processing a moving picture is provided with: a memory for recording a plurality of moving pictures including a moving picture having information added to part of the frames thereof; a first display for displaying part of the frames of the moving pictures recorded in the memory; a discriminator for checking whether or not a moving picture that includes any of the frames displayed by the first display includes a frame to which information is added; and a second display for displaying, when a moving picture that includes any of the frames displayed by the first display includes a frame to which information is added, an indicator with respect to that moving picture to indicate that it includes a frame to which information is added.

This moving picture processing apparatus displays representative frames of moving pictures, and lets the user select the moving picture that corresponds to the frame that the user specifies. To a moving picture having information added to any of its frame, an indicator is added that indicates the addition of information. This permits the user to readily recognize whether or not a moving picture includes a frame to which information is added, and thus makes selection of a moving picture easy, for example, at the time of playback.

The first display may display, in an arranged manner, a plurality of frames included in different moving pictures. This permits the user to recognize, for a plurality of moving pictures at a time, whether or not they include a frame to which information is added.

Information added to a frame may be in the form of text, sound, or an image. The second display may display the indicator in one of different manners according to the type of the information.

A third display may additionally be provided that displays, when any of the frames displayed by the first display has information added in a particular region thereon, that frame anew in a manner that indicates the region. This permits the user, even when information is added in a particular region on a frame, to readily recognize the region.

According to another aspect of the present invention, a method for processing a moving picture includes the steps of displaying part of the frames included in a plurality of moving pictures; checking whether or not a moving picture that includes any of the displayed frames includes a frame to which information is added; and displaying, when a moving picture that includes any of the displayed frames includes a frame to which information is added, an indicator with respect to that moving picture to indicate that it includes a frame to which information is added.

By adopting this method, it is possible to easily realize the moving picture processing apparatus described above. For that purpose, it is advisable to record the steps described above in the form of a program to be run on a computer.

According to another aspect of the present invention, an apparatus for processing a moving picture is provided with: a memory for recording a moving picture having information added to part of the frames thereof; an image reproducer for playing back the moving picture recorded in the memory; an information reproducer for playing back the information added to part of the frames of the moving picture recorded in the memory; a selector for selecting, according to a command from a user, among a first playback mode in which, when the frames having the information added thereto are played back, the information is not played back, a second playback mode in which only the frames having the information added thereto are played back together with the information, and a third playback mode in which, when the frames having the information added thereto are played back, the information is played back; and a controller for controlling the playback of the moving picture by the image reproducer and the playback of the information by the information reproducer according to the playback mode selected by the selector.

This moving picture processing apparatus plays back a moving picture in one of three playback modes. In the first playback mode, the moving picture is played back without the information played back. In the second playback mode, only those frames to which the information is added are played back together with the information. When the added information is not needed, the user can select the first playback mode to display the images alone. When the frames to which no information is added need not be played back, the user can select the second playback mode. In the third playback mode, the moving picture is played back with the information played back together with the frames to which it is added. When not only the frames having the information added thereto but also the frames having no information added thereto need to be played back, and in addition the information also needs to be played back, the user can select this playback mode.

Information added to a frame may be in the form of text, sound, or an image.

In the second and third playback modes, the image reproducer may, if a frame to be played back has information added in a particular region thereon, display the region. This helps make it clear to which region on a frame information corresponds, and thus helps secure the significance of adding information in a particular region on a frame.

According to another aspect of the present invention, a method for processing a moving picture includes the steps of: recording a moving picture having information added to part of the frames thereof; selecting among a first playback mode in which, when the frames having the information added thereto are played back, the information is not played back, a second playback mode in which only the frames having the information added thereto are played back together with the information, and a third playback mode in which, when the frames having the information added thereto are played back, the information is played back; and playing back the moving picture and the information according to the selected playback mode.

By adopting this method, it is possible to easily realize the moving picture processing apparatus described above. For that purpose, it is advisable to record the steps described above in the form of a program to be run on a computer.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a diagram schematically showing the basic configuration of a moving picture processing apparatus embodying the invention;

FIG. 2 is a diagram schematically showing the configuration of a personal computer as one practical example of a moving picture processing apparatus;

FIGS. 3A and 3B are diagrams schematically showing the configuration of a digital camera as another practical example of a moving picture processing apparatus;

FIG. 4 is a diagram schematically showing the structure of the data of a moving picture and information stored in the data storage portion;

FIG. 5 is a diagram showing an example of the operation guide displayed on the display portion for selection of an operation mode;

FIG. 6 is a flow chart showing the flow of operations performed by the controller portion for selection of an operation mode;

FIGS. 7A to 7F are diagrams showing examples of the operation guide displayed on the display portion in add-information mode 1;

FIGS. 8A and 8B are diagrams showing examples of the operation guide displayed on the display portion in add-information mode 1;

FIG. 9 is a flow chart showing the flow of operations performed by the controller portion in add-information mode 1;

FIGS. 10A to 10D are diagrams showing examples of the operation guide displayed on the display portion in add-information mode 2;

FIG. 11 is a diagram showing an example of the operation guide displayed on the display portion in add-information mode 2;

FIG. 12 is a flow chart showing the flow of operations performed by the controller portion in add-information mode 2;

FIGS. 13A to 13E are diagrams showing examples of the operation guide displayed on the display portion in add-information mode 3;

FIGS. 14A to 14D are diagrams showing examples of the operation guide displayed on the display portion in add-information mode 3;

FIG. 15 is a flow chart showing the flow of operations performed by the controller portion in add-information mode 3;

FIGS. 16A and 16B are diagrams showing examples of the operation guide displayed on the display portion in add-information mode 4;

FIG. 17 is a flow chart showing the flow of operations performed by the controller portion in add-information mode 4;

FIGS. 18A to 18D are diagrams showing examples of the operation guide displayed on the display portion for entry of information in the add-information mode;

FIG. 19 is a flow chart showing the flow of operations performed by the controller portion for entry of information in the add-information mode;

FIGS. 20A to 20C are diagrams showing examples of the operation guide displayed on the display portion at the start of the play-back-movie mode;

FIGS. 21A to 21D are diagrams showing examples of the operation guide displayed on the display portion for selection of a submode in the play-back-movie mode;

FIG. 22 is a flow chart showing the flow of operations performed by the controller portion in the play-back-movie mode;

FIGS. 23A and 23B are diagrams showing examples of the operation guide displayed on the display portion in the information playback mode;

FIG. 24 is a flow chart showing the flow of operations performed by the controller portion in the information playback mode;

FIGS. 25A to 25C are diagrams showing examples of the operation guide displayed on the display portion in the through playback mode; and

FIG. 26 is a flow chart showing the flow of operations performed by the controller portion in the through playback mode.

### DESCRIPTION OF THE PREFERRED EMBODIMENTS

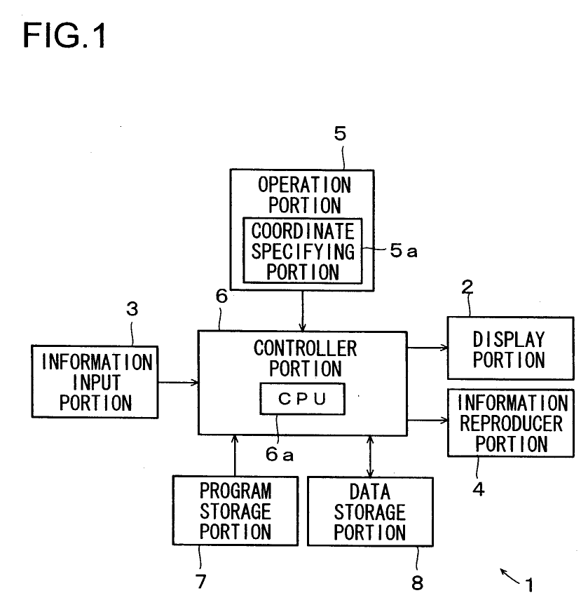

Hereinafter, a moving picture processing apparatus embodying the present invention will be described with reference to the drawings. FIG. 1 schematically shows the basic configuration of the moving picture processing apparatus 1. The moving picture processing apparatus 1 is composed of a display portion 2 for displaying a moving picture and an operation guide, an information input portion 3 for accepting input of information to be added to a moving picture, an information reproducer portion 4 for playing back information added to a moving picture, an operation portion 5 for accepting selection of a frame from among those constituting a moving picture, a controller portion 6 having a CPU 6a for controlling the operation of the entire apparatus, a program storage portion 7 for storing a program containing instructions for control operations to be executed by the CPU 6a, and a data storage portion 8 for storing moving pictures and information. The display portion 2 is realized with a display device, such as a liquid crystal display (LCD) or cathode ray tube (CRT).

The moving picture processing apparatus 1 deals with information in the form of sound, text (strings of characters), or images. When information in the form of sound is dealt with, the information input portion 3 is, for example, a microphone, and the information reproducer portion 4 is, for example, a loudspeaker. When information in the form of text is dealt with, the information input portion 3 is, for example, a keyboard, and the information reproducer portion 4 is, for example, a display device. When information in the form of images is dealt with, the information input portion 3 is, for example, a digital camera, and the information reproducer portion 4 is, for example, a display device. When information in the form of text or images is dealt with, the display portion 2 can be shared as the information reproducer portion 4.

The operation portion 5 is realized with a member that, when operated by the user, detects the operation done by the user, examples of such a member including keys, dials, and the like. The operation portion 5 includes a coordinate specifying portion 5a, which is realized with a member that, when operated by the user, detects the position specified by the user who points a position (coordinates) within a predetermined region on a plane corresponding to the display surface of the operation portion 5, examples of such a member including keys, dials, a stylus, a track ball, a joystick, and the like. On the display portion 2, a pointer (cursor) that moves in an interlocked manner as the coordinate specifying portion 5a is operated is displayed along with an operation guide. In the operation guide are shown the names of commands that can be fed to the controller portion 6. The user proceeds with desired operations by, through the operation of the coordinate specifying portion 5, moving the pointer to select a command after another.

The program storage portion 7 is realized with a nonvolatile storage medium that may be rewritable or non-rewritable. Examples of the storage medium used as the program storage portion 7 include a semiconductor ROM, a semiconductor EEPROM, a semiconductor flash memory, a CD-ROM, a hard disk, and the like. The data storage portion 8 is realized with a nonvolatile, rewritable storage medium. Examples of the storage medium used as the data storage portion 8 include a semiconductor flash memory, a DVD-RAM, a hard disk, a flexible disk, a memory card incorporating a semiconductor flash memory, and the like. Any information, whether in the form of sound, text, or images, is stored as digital signals.

The program storage portion 7 and the data storage portion 8 each may be non-removably fitted or removably mounted. The moving picture processing apparatus 1 may even be provided with a communication portion for communicating with an external device so as to receive a moving picture from the external device and transmit a moving picture having information added thereto to the external device.

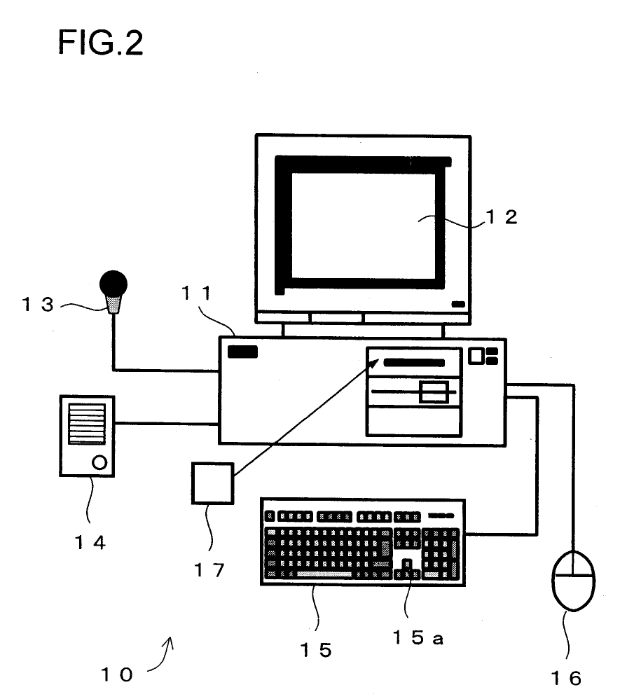

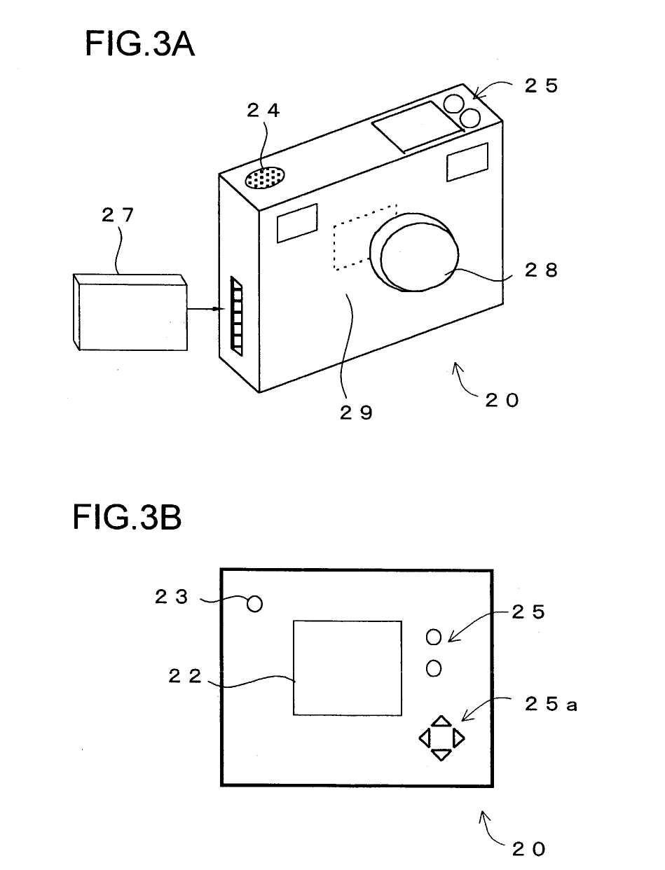

As practical examples of the moving picture processing apparatus 1, FIG. 2 shows a personal computer 10, and FIGS. 3A and 3B show a digital camera 20. The personal computer 10 shown in FIG. 2 is provided with a CRT 12 as the display portion 2, a microphone 13 and a keyboard 15 as the information input portion 3, a loudspeaker 14 as the information reproducer portion 4, and a mouse 16 as the coordinate specifying portion 5a of the operation portion 5. The CRT 12 functions also as the information reproducer portion 4 for displaying information in the form of text. The keyboard 15 functions also as the operation portion 5, and includes cursor keys 15a that function also as the coordinate specifying portion 5a.

The personal computer 10 incorporates, in its main body 11, individual units that function as the controller portion 6, program storage portion 7, and data storage portion 8, respectively. A program containing instructions to be executed by the CPU 6a is stored in a storage medium incorporated in the personal computer 10 at the time of its fabrication, but may also be supplied from a removable storage medium 17. Data of a moving picture is supplied from the removable storage medium 17, and the information in the form of sound, text, and images added to a moving picture by the personal computer 10 is stored in the storage medium 17.

FIG. 3A is a perspective view of the digital camera 20, and FIG. 3B is a rear view thereof The digital camera 20 is capable of shooting both still and moving pictures. The digital camera 20 is provided with, in addition to a taking lens 28 and a CCD area sensor 29 for shooting pictures, an LCD 22 as the display portion 2, a microphone 23 as the information input portion 3, a loudspeaker 24 as the information reproducer portion 4, and some keys 25 as the operation portion 5. The keys 25 includes cursor keys 25a that function as the coordinate specifying portion 5a.

The digital camera 20 incorporates individual units that function as the controller portion 6, program storage portion 7, and data storage portion 8, respectively. A program containing instructions to be executed by the CPU 6a is stored in a storage medium incorporated in the digital camera 20 at the time of its fabrication, but may also be supplied from a removable storage medium 27. Data of a moving picture is supplied from the storage medium 27, or is shot by the digital camera 20 itself and is then stored in the storage medium 27.

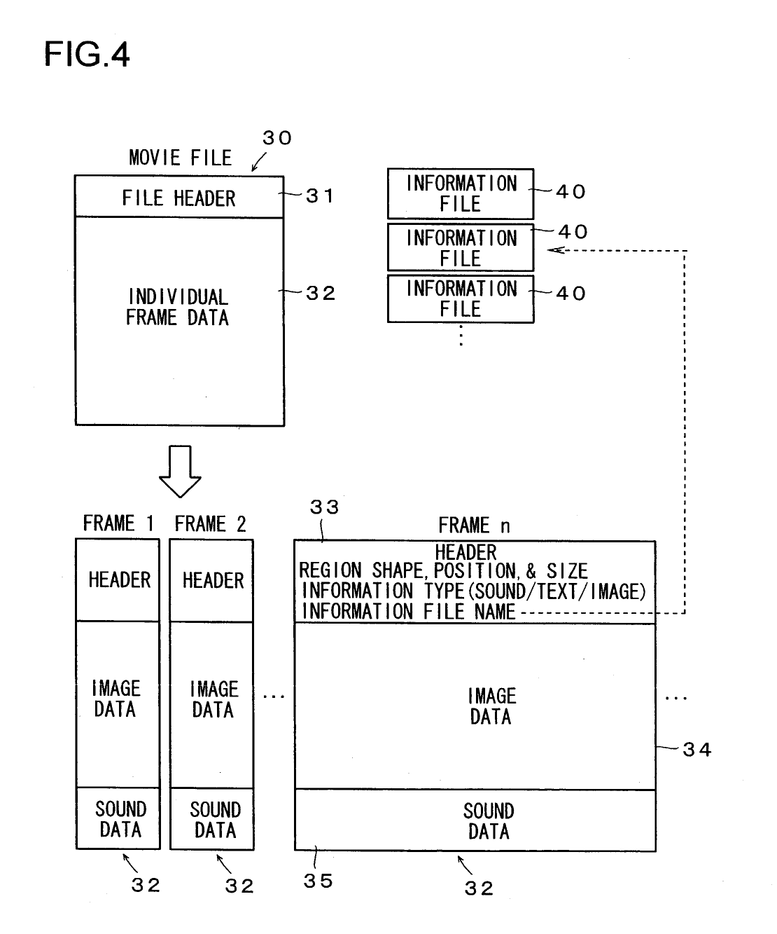

Hereinafter, how information is added to a moving picture and how a moving picture is played back in the moving picture processing apparatus 1 of this embodiment will be described in detail. FIG. 4 schematically shows the data structure of a moving picture and information stored in the data storage portion 8. A moving picture is stored in a single movie file 30 containing all of its constituent frames. Information added to the moving picture is stored in separate information files 40.

The movie file 30 is composed of a header 31 and data 32 of the individual frames. In the header 31 are recorded, in addition to the total number of frames, the data size of each frame, and the like, whether or not any frame has information added thereto and, if any, the number of the frame (if a series of consecutive frames has information added thereto, the numbers of the first and last of those frames) and the type of the information (whether in the form of sound, text, or an image).

It is to be noted that it is possible to add different items of information to different frames within a single moving picture, and those different items of information so added may be of different types. When different types (forms) of information are added, all of those types are recorded in the header 31.

The data 32 of the individual frames is composed of, for each frame, a header 33, image data 34 representing an image, and sound data 35 representing sound. Here, the sound represented by this sound data is that which was added to all the frames when the moving picture was shot, and is different from information that is added to part of the frames according to the present invention. When a frame has information added thereto, in its header 33 are recorded the shape, position, and size of the region on that frame in which information is added, the type of the information added, and the name of the information file 40 in which the information is stored.

As described above, in the moving picture processing apparatus 1, information and the region in which it is added are stored in association with a frame. Each information file 40 contains sound data, text data, or image data depending on whether the information stored therein is in the form of sound, text, or an image.

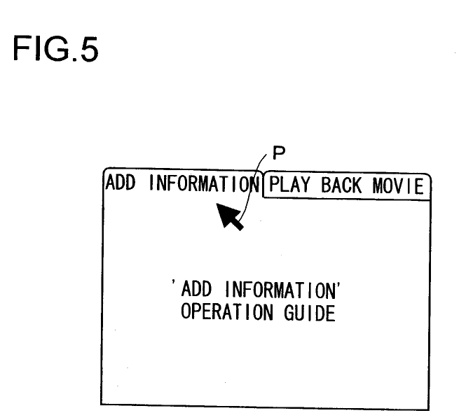

The moving picture processing apparatus 1 processes a moving picture (hereinafter also a movie) in one of two operation modes, namely either in an add-information mode in which it adds information in a region on part of the frames constituting the moving picture or in a play-back-movie mode in which it plays back the moving picture. FIG. 5 shows the operation guide displayed on the display portion 2 to let the user select an operation mode. The operation guide has two pages, one for each operation mode, with the names of the operation modes shown at the tabs of the respective pages. These two pages are shown overlapping, and the user selects a desired operation mode by, through the operation of the coordinate specifying portion 5a, moving the pointer P onto the tab of the page of the desired operation mode.

When one of the operation modes is selected, the page for it is shown above that for the other and becomes visible in its entirety, with some commands corresponding to the selected operation mode shown therein. Thereafter, the user proceeds with desired operations by selecting an appropriate command after another. It is to be noted that commands shown in the operation guide vary depending on the stage of operation.

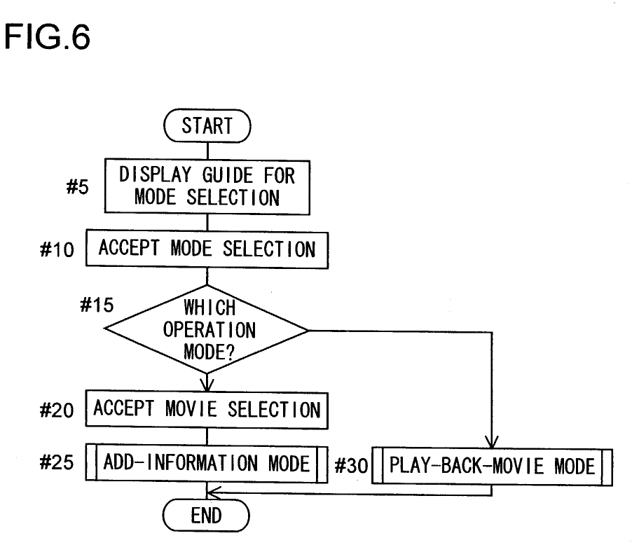

FIG. 6 shows the flow of operations performed by the controller portion 6 when an operation mode is selected. First, the operation guide for mode selection shown in FIG. 5 is displayed (step #5). Then, selection of an operation mode is accepted (#10), and, according to the mode selected (#15), either the add-information mode (#25) or the play-back-movie mode (#30) is started. When the add-information mode is selected, a predetermined guide for letting the user select a moving picture is displayed, and selection of a moving picture is accepted (#20). When the play-back-movie mode is selected, after the play-back-movie mode is started, a predetermined guide for letting the user select a moving picture is displayed, and selection of a moving picture is accepted.

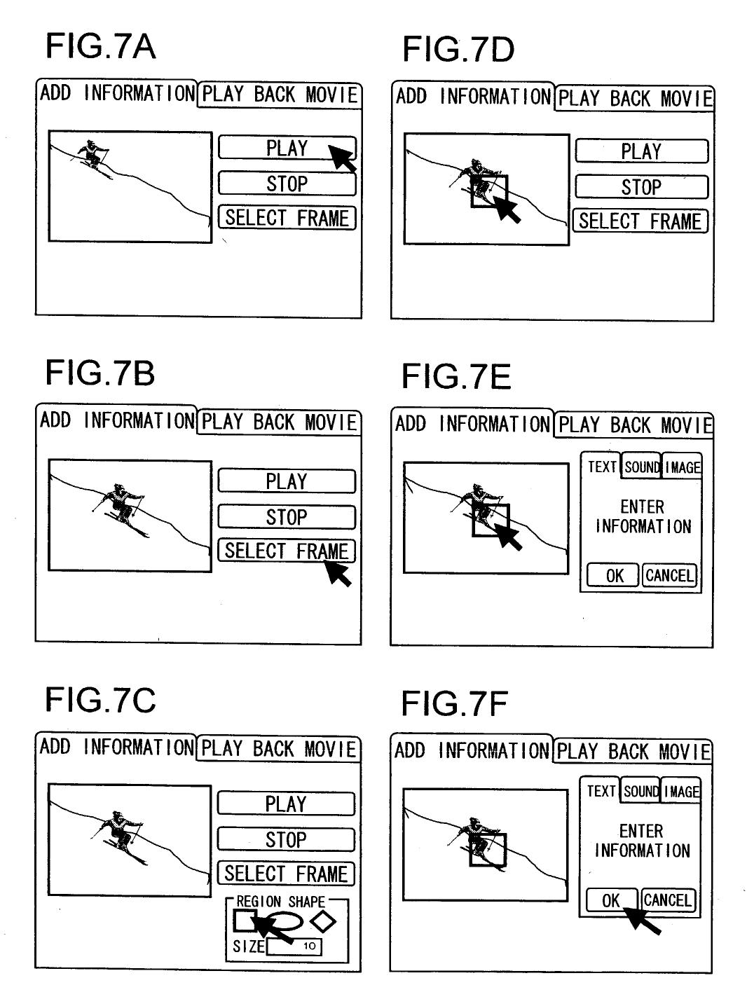

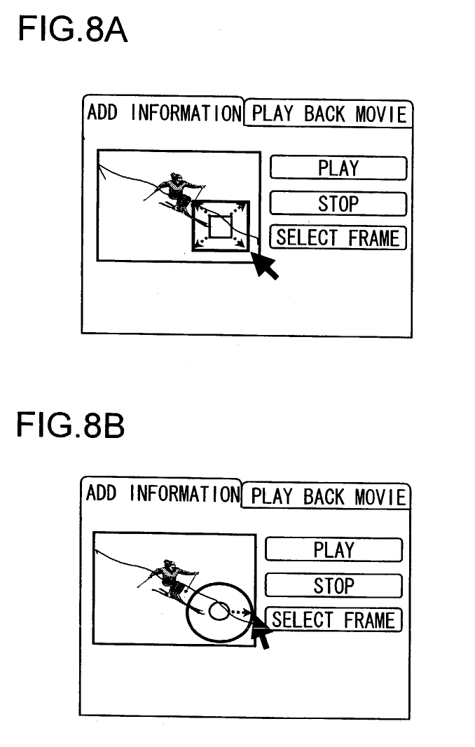

The add-information mode is divided into four submodes. First, a first submode, called add-information mode 1, will be described. In add-information mode 1, while a moving picture is being played back, the user is allowed to halt the playback at a desired frame to select the frame, specify a region on the so selected frame, and add information in that region. FIGS. 7A to 7F and 8A and 8B show examples of the operation guide displayed on the display portion 2 in add-information mode 1.

In the operation guide are shown three commands, namely “play,” “stop,” and “select frame.” The user first selects “play” to start playing back the moving picture (FIG. 7A), and, when a desired frame is displayed, the user selects “select frame” to halt the playback (FIG. 7B). When the playback is halted, a guide for letting the user specify the shape and size of the region in which to add information is displayed, in response to which the user selects a desired shape and sets its size (FIG. 7C). Next, the user moves the pointer into the frame being displayed in order to specify a region in which to add information (FIG. 7D). Wherever the pointer is located is set as the center of the region.

After the region is specified, a guide for letting the user enter information is displayed (FIG. 7E). In this guide are shown commands “text,” “sound,” and “image.” The user selects one of these to specify the type of information, and then enters information by the use of whichever information input portion 3 is suitable for the selected type, for example the keyboard for text and the microphone for sound. When the selected type is image, the user enters the name of an information file containing image data, and prepares the information file separately. After the information is entered, the user selects “OK” to request it to be stored (FIG. 7F). Instead, the user may select “cancel” to cancel the entered information.

Here, the size of the region is specified with a value. Alternatively, it is also possible, as shown in FIGS. 8A and 8B, to select only the shape of a region first, then determine its center within the frame, and then move the pointer to set its size. In this case, if the region is circular, its radius can be set, and, if the region is rectangular or rhombic, its width and height can be set separately.

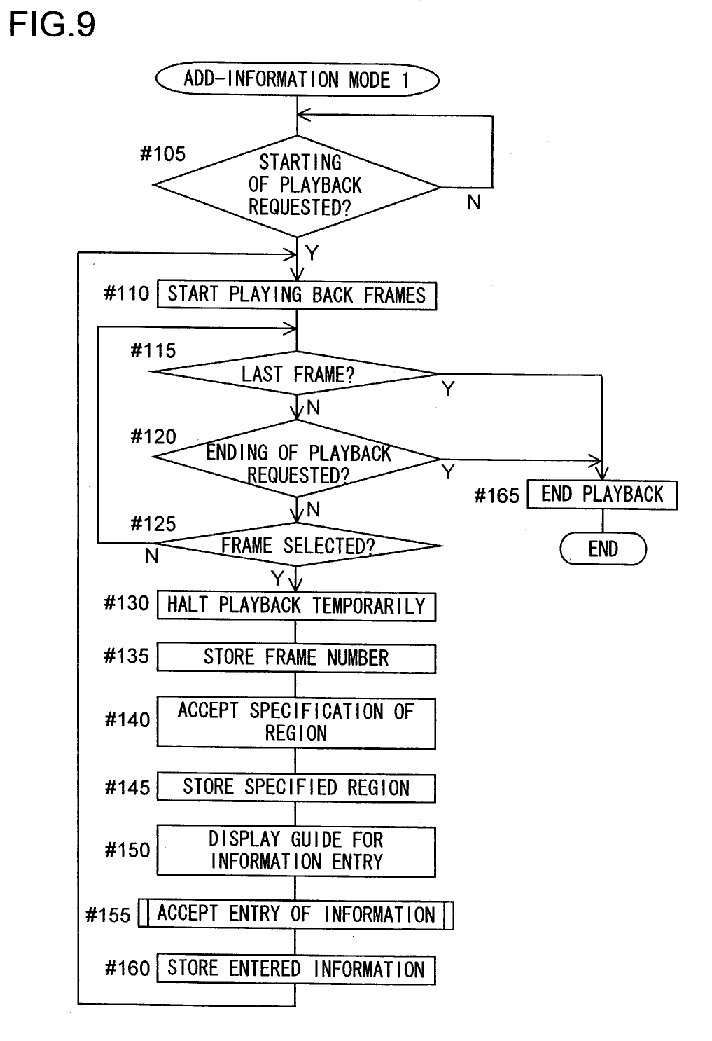

FIG. 9 shows the flow of operations performed by the controller portion 6 in add-information mode 1. First, when “play” is selected and thereby starting of playback is requested (step #105), the moving picture starts being played back from its first frame (#110). Then, whether or not the moving picture has been played back up to its last frame is checked (#115), and, if it has not yet been played back up to its last frame, whether or not “stop” is selected to stop the playback is checked (#120).

If no request is made to stop the playback, whether or not “select frame” is selected to request selection of the currently displayed frame is checked (#125), and, if no such request is made, the flow returns to step #115.

If selection of the currently displayed frame is requested, the playback is halted temporarily (#130), and the number of the frame is stored (#135). Next, specification of a region is accepted (#140), and the shape, position, and size of the specified region are recorded in the header of the frame of which the number was stored in step #135 (#145). Then, a guide for entry of information is displayed (#150), entry of information is accepted (#155), an information file 40 in which the entered information is stored is created, and the name of this file is recorded in the header of the frame of which the number was stored in step #135 (#160). The flow then returns to step #110. In a case where the information is in the form of an image, entry of the name of an information file is accepted in step #155, and no information file is created anew in step #160.

If, in step #115, it is found that the moving picture has been played back up to its last frame, or if, in step #120, it is found that ending of the playback is requested, the playback is ended (#165). By making the flow return from the step #160 to #110, it is possible to add information to a plurality of frames while the moving picture is being played back once, and it is also possible to add different types (forms) of information to different frames.

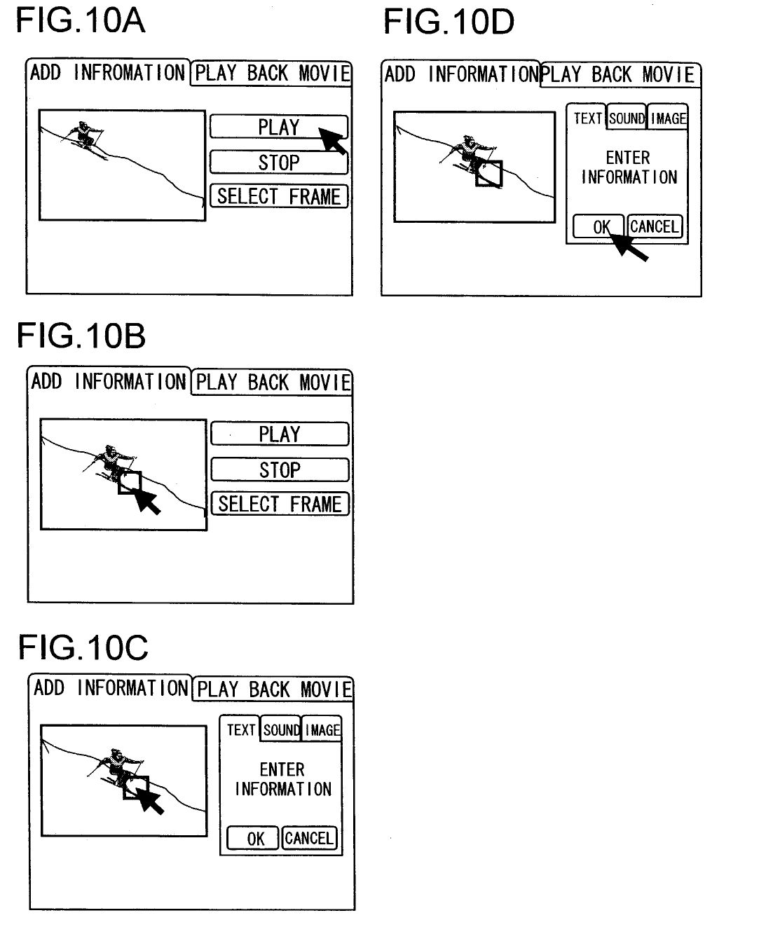

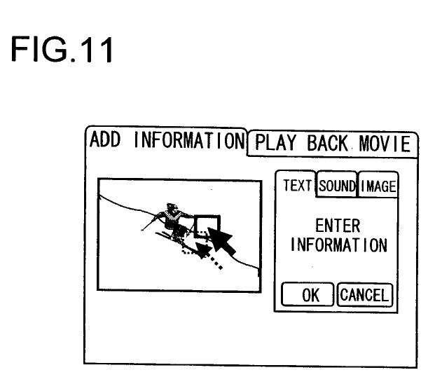

Next, a second submode of the add-information mode, called add-information mode 2, will be described. In the add-information mode 2, while a moving picture is being played back, the user is allowed to select a series of frames by continuously operating a predetermined member (for example the left button of the mouse 16) of the operation portion 5. Moreover, when a frame is selected, by placing the pointer on the frame being displayed, the user can specify the position of a region on the selected frame. FIGS. 10A to 10D and 11 show examples of the operation guide displayed on the display portion 2 in add-information mode 2.

The operation guide displayed first here is the same as in add-information mode 1 for coherence's sake, though “select frame” is not used in this submode. The user first selects “play” to start playing back the moving picture (FIG. 10A). Then, the user moves the pointer into the frame being displayed, and, when a desired frame is displayed, the user starts operating a predetermined member (for example, keeping the left button of the mouse 16 pressed) (FIG. 10B). Thereafter, when another desired frame is displayed, the user ends the operation (FIG. 10C). While the predetermined member is being operated, a region having its center at where the pointer is placed and having a predetermined shape and size is displayed. Moreover, as soon as the operation is started, a guide for entry of information is displayed. After the operation is complete, the user, in the manner described earlier, enters information, and requests it to be stored (FIG. 10D).

Here, as shown in FIG. 11, the pointer may be moved while the region is being displayed. This makes it possible to vary from one frame to another the region in which to add information.

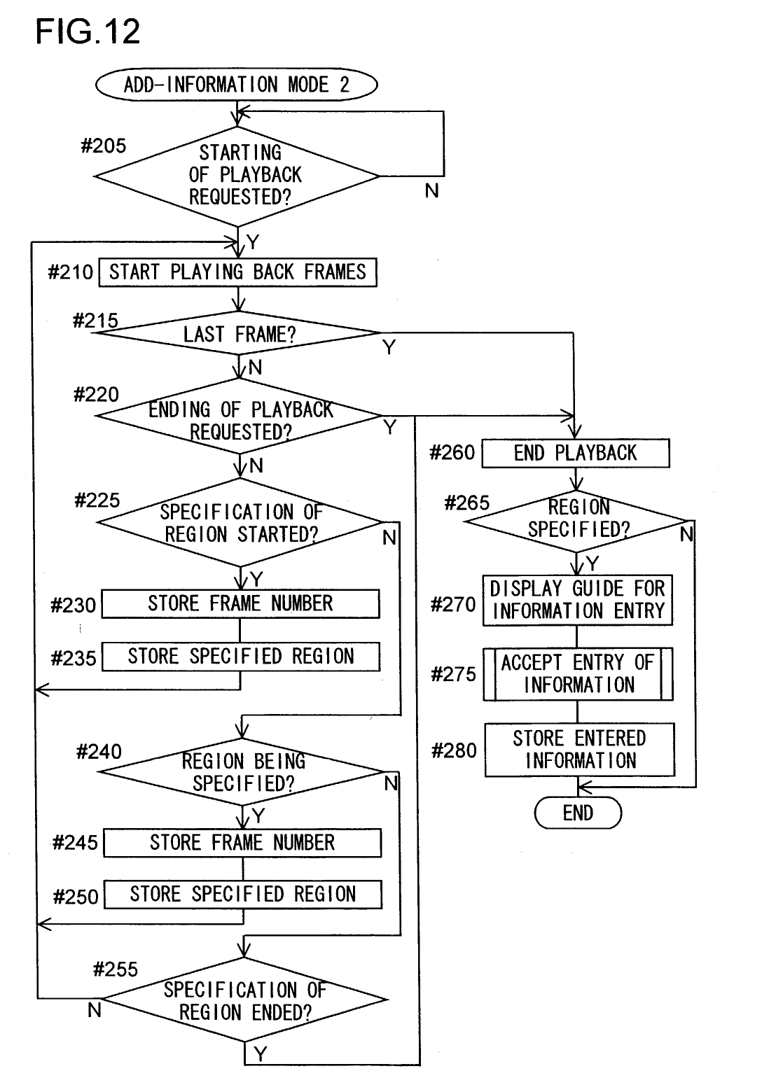

FIG. 12 shows the flow of operations performed by the controller portion 6 in add-information mode 2. First, when “play” is selected and thereby starting of playback is requested (step #205), the moving picture starts being played back from its first frame (#210). Then, whether or not the moving picture has been played back up to-its last frame is checked (#215), and, if it has not yet been played back up to its last frame, whether or not “stop” is selected to stop the playback is checked (#220).

If no request is made to stop the playback, whether or not the predetermined member starts being operated to request starting of specification of a region (selection of a frame) is checked (#225), and, if such a request is made, the number of the frame is stored (#230), and the shape, position, and size of the region are recorded in the header of that frame (#235). The flow then returns to step #215.

If, in step #225, it is found that no request is made to start specifying a region, whether or not the predetermined member has already been started being operated and a region is already being specified is checked (#240). If a region is already being specified, the number of the frame being displayed is stored (#245), the shape, position, and size of the region are recorded in the header of that frame (#250), and the flow then returns to step #215.

If, in step #240, it is found that no region is being specified, i.e., the predetermined member is not being operated, whether or not specification of a region has ended or not, i.e. whether or not a region was being specified up to the immediately preceding frame, is checked (#225). Unless specification of a region is complete, the flow returns to step #215.

If, in step #215, it is found that the moving picture has been played back up to its last frame, or if, in step #220, it is found that ending of the playback is requested, or if, in step #225, it is found that specification of a region has ended, the playback of the moving picture is ended (#260). Then, whether or not a region has been specified, i.e., whether or not any frame has been selected, is checked (#265). If no region has been specified, the flow ends. If one or more regions have been specified, a guide for entry of information is displayed (#270), entry of information is accepted (#275), the entered information is recorded in an information file 40, and the name of this file is recorded in the header of the frames of which the numbers were stored in steps #230 and #245 (#280).

Add-information mode 2 ends when information is added to a series of frames. However, it is possible to process the same moving picture a plurality of times through add-information mode 2. This makes it possible to add different items of information to different series of frames within a single moving picture, and those different items of information may be of different types.

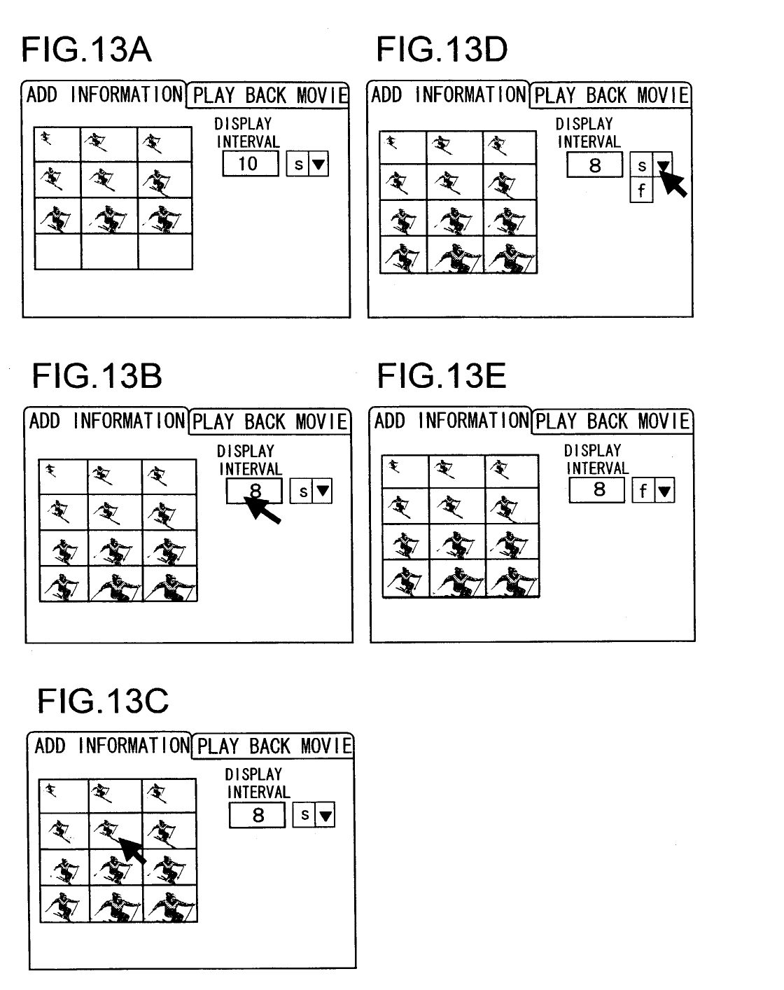

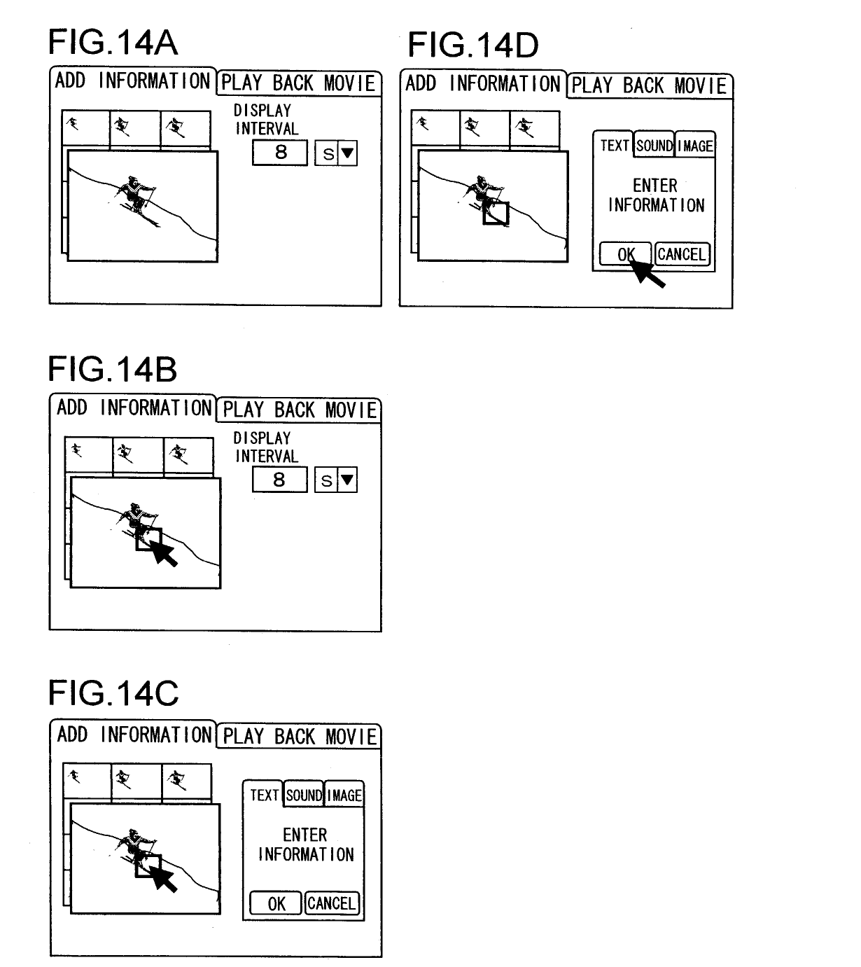

Next, a third submode of the add-information mode, called add-information mode 3, will be described. In the add-information mode 3, the user is allowed to display a plurality of frames in an arranged manner, select one from among them, and specify a region on the so selected frame. The frames displayed in an arranged manner are displayed as thumbnail images on a reduced scale to permit many frames to be displayed at a time. On the other hand, the selected frame is displayed anew in its original, i.e. not reduced, size to permit a region to be specified accurately. FIGS. 13A to 13E and 14A to 14D show examples of the operation guide displayed on the display portion 2 in add-information mode 3.

In the operation guide are shown a value that represents the intervals at which the frames displayed in an arranged manner are located within a moving picture and a symbol “s” or “f” that represents the unit of the intervals. The units can be switched as shown in FIGS. 13D and 13E. Here, the symbol “s” indicates that frames are selected at predetermined time intervals (seconds) at which they appear when played back. For example, in the example shown in FIG. 13A, frames are selected and displayed at intervals of 10 seconds. On the other hand, the symbol “f” indicates that one among every predetermined number of frames is selected. For example, in the example shown in FIG. 13E, one among every eight frames is selected. Thus, if “f” is specified as the unit and “1” as the interval, frames are selected consecutively.

First, a plurality of frames are displayed in an arranged manner at predetermined display intervals and with a predetermined unit (FIG. 13A). When a different display interval or unit is specified, the frames displayed in an arranged manner are refreshed accordingly (FIG. 13B). The user places the pointer on a desired frame to select it (FIG. 13C). When a frame is selected, the frame is displayed anew in its original, i.e., not reduced, size (FIG. 14A). Thereafter, the user, by the same procedure as described earlier in connection with add-information mode 1, specifies a region (FIG. 14B), enters information (FIG. 14C), and stores the entered information (FIG. 14D).

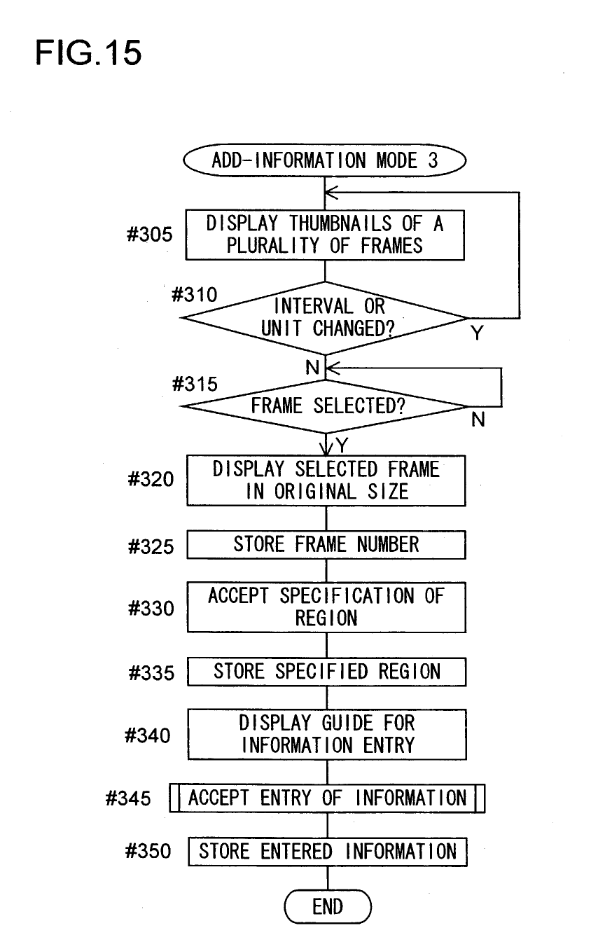

FIG. 15 shows the flow of operations performed by the controller portion 6 in add-information mode 3. First, from among all the frames constituting a moving picture, a plurality of frames are selected at predetermined intervals and with a predetermined unit, and those frames are displayed as thumbnail images in an arranged manner (step #305). Next, whether or not a change in the interval or unit is requested is checked (#3 10), and, if any such change is requested, the flow returns to step #305 to refresh what is displayed.

Thereafter, whether or not any of the displayed frames is selected is checked, and, if none is selected, a wait lasts until one is selected (#315). When a frame is selected, the frame is displayed in its not reduced size (#320), and the number of the frame is stored (#325). Then, specification of a region is accepted (#330), and the specified region is recorded in the header of the frame of which the number was stored in step #325 (#335). Moreover, a guide for entry of information is displayed (#340), and entry of information is accepted (#345). Then, the entered information is recorded in an information file 40, and the name of this file is recorded in the header of the frame of which the number was stored in step #325 (#350), ending the flow.

Here, only the intervals at which to display frames in an arranged manner is specified. However, it is possible to allow also specification of the first frame to be displayed in an arranged manner. This makes it possible to exactly select a frame to which to add information even when the moving picture contains a large number of frames.

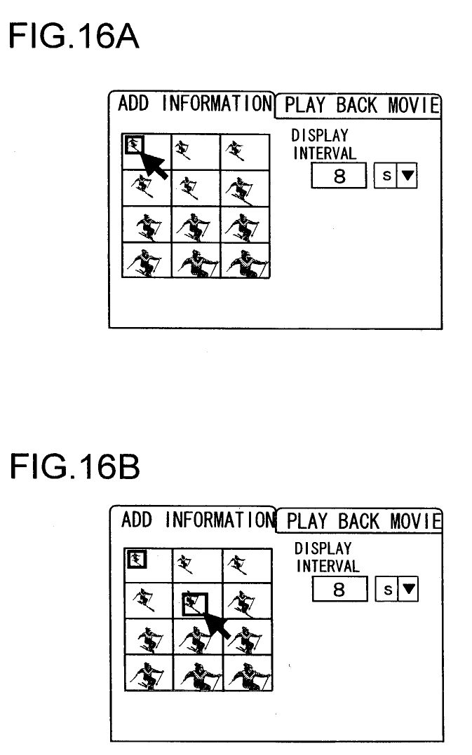

Next, a fourth submode of the add-information mode, called add-information mode 4, will be described. In the add-information mode 4, the user is allowed to display a plurality of frames in an arranged manner, select two from among them, and specify regions individually on the so selected frames. The controller portion 6 regards all of the frames located between the two selected frames as selected, and allocates regions to which to add information also on those frames. The positions and sizes of the regions allocated on the intermediary frames are determined through interpolation based on the two selected frames. Thus, simply by selecting two frames and specifying regions thereon, a series of frames is selected and regions are set on them. FIGS. 16A and 16B show examples of the operation guide displayed on the display portion 2 in add-information mode 4.

The operation guide is the same as in the add-information mode 3, and the frames displayed in an arranged manner are displayed as thumbnail images on a reduced scale. The display interval and its unit can be changed. Here, however, a region is specified directly on a thumbnail image, without displaying a selected frame anew in its not reduced size. The user first places the pointer on a frame to select it, and then specifies a region thereon (FIG. 16A). Next, the user places the pointer on another frame to select it, and then specifies a region thereon (FIG. 16B). These two frames may be selected in either order; namely, among a series of frames to be selected, either the first or the last may be selected first.

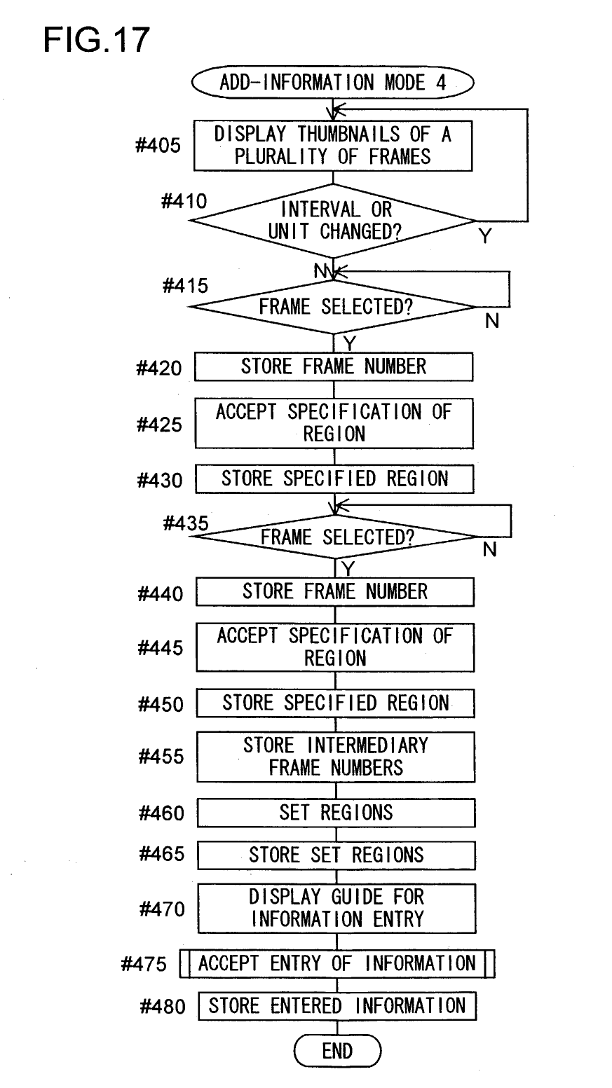

FIG. 17 shows the flow of operations performed by the controller portion 6 in add-information mode 4. First, from among all the frames constituting a moving picture, a plurality of frames are selected at predetermined intervals and with a predetermined unit, and those frames are displayed as thumbnail images in an arranged manner (step #405). Next, whether or not a change in the interval or unit is requested is checked (#410), and, if any such change is requested, the flow returns to step #405 to refresh what is displayed.

Thereafter, whether or not any of the displayed frames is selected is checked, and, if none is selected, a wait lasts until one is selected (#415). When a frame is selected, the number of the frame is stored (#420). Then, specification of a region is accepted (#425), and the specified region is recorded in the header of the frame of which the number was stored in step #420 (#430).

Thereafter, a wait lasts until another frame is selected (#435), and, when one more is selected, the number of the frame is stored (#440). Then, specification of a region is accepted (#445), and the specified region is recorded in the header of the frame of which the number was stored in step #440 (#450).

Next, the numbers of all of the frames located between the two frames of which the numbers were stored in steps #420 and #440 are stored (#455). Then, for each of those frames, the position and size of a region is determined through interpolation based on the positions and sizes of the two regions specified in step #425 and #445, on the numbers of the frames stored in steps #420 and #440, and on the number of the frame in question (#460), and then the region so determined is recorded in the header (#465).

Thereafter, a guide for entry of information is displayed (#470), and entry of information is accepted (#475). Then, the entered information is recorded in an information file 40, and the name of this file is recorded in the headers of the two frames of which the numbers were stored in steps #420 and #440 and in the headers of all the frames of which the numbers were stored in step #455 (#480), ending the flow.

Here, regions are specified individually on the two selected frames. However, it is also possible to specify a region on only one of the two selected frames. In that case, the specified region is set on both of the selected frames and on all of the intermediary frames located between them.

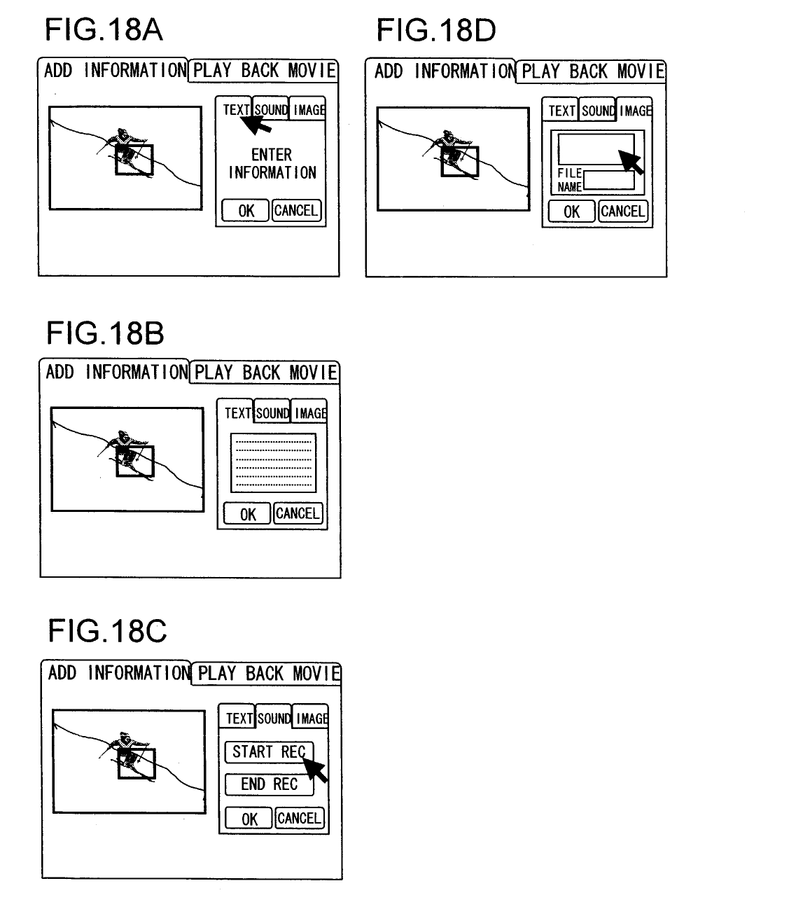

Now, the procedure for accepting entry of information in the add-information mode (specifically, step #155 in FIG. 9, step #275 in FIG. 12, step #345 in FIG. 15, and step #475 in FIG. 17) will be described in more detail. As described earlier, to accept entry of information, an operation guide is displayed. FIGS. 18A to 18D show examples of the operation guide for that purpose.

To enter information in the form of text, the user selects “text” (FIG. 18A). When “text” is selected, a box in which to display text is shown in the operation guide (FIG. 18B), and the text entered through the information input portion 3 (key board) is displayed in the box.

To enter information in the form of sound, the user selects “sound.” When “sound” is selected, commands “start recording” and “end recording” are shown in the operation guide. When “start recording” is selected, sound starts being recorded (FIG. 1 8C). The user enters sound through the information input portion 3 (microphone). When “end recording” is selected, the recording of sound is ended.

To enter information in the form of an image, the user selects “image.” When “image” is selected, in the operation guide are shown a box with a list of the names of image data files displayed therein and a box in which an entered file name is to be displayed (FIG. 18D). The user, if the displayed list of file names includes a desired one, selects that one, and, if not, selects the box for displaying a to-be-entered file name and enters a file name through the information input portion 3 (keyboard). The file name thus entered is displayed. If, at the time of entry of information, an information file containing image data has already been created, the name of that file can be selected; if no such information file has been created yet, a file name needs to be entered, and the corresponding information file will be created later.

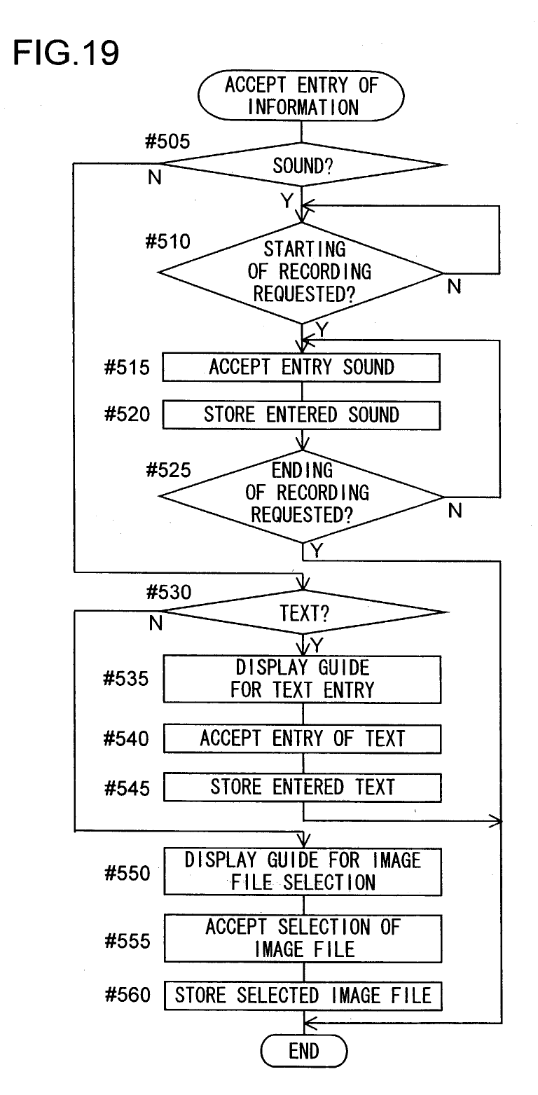

FIG. 19 shows the flow of operations performed by the controller portion 6 to accept entry of information. First, based on which of “sound,” “text,” and “image” is selected, whether or not the information that is going to be entered is in the form of sound is checked (step #505). If the information is in the form of sound, whether or not starting of recording is requested is checked (#510). When starting of recording is requested, entry of sound is accepted (#515), and the entered sound is recorded in an information file 40 (#520). Next, whether or not ending of the recording is requested is checked (#525). If no such request is made, the flow returns to step #515; if such a request is made, the flow ends.

If, in step #505, it is found that the information is not in the form of sound, then whether or not it is in the form of text is checked (#530). If the information is in the form of text, a guide for entry of text is displayed (#535), entry of text is accepted (#540), the entered text is recorded in an information file 40 (#545), and the flow ends.

If, in step #530, it is found that the information is not in the form of text, i.e., if the information is in the form of an image, a guide for selection of an information file and for entry of a file name is displayed (#550), and selection of a file or entry of a file name is accepted (#555). Then, the selected or entered file name is stored (#560), and the flow ends.

In the add-information modes 1 to 4 described earlier, it is after a frame is selected and a region specified thereon that information is entered. However, it is also possible to enter information first and then select a frame and specify a region thereon.

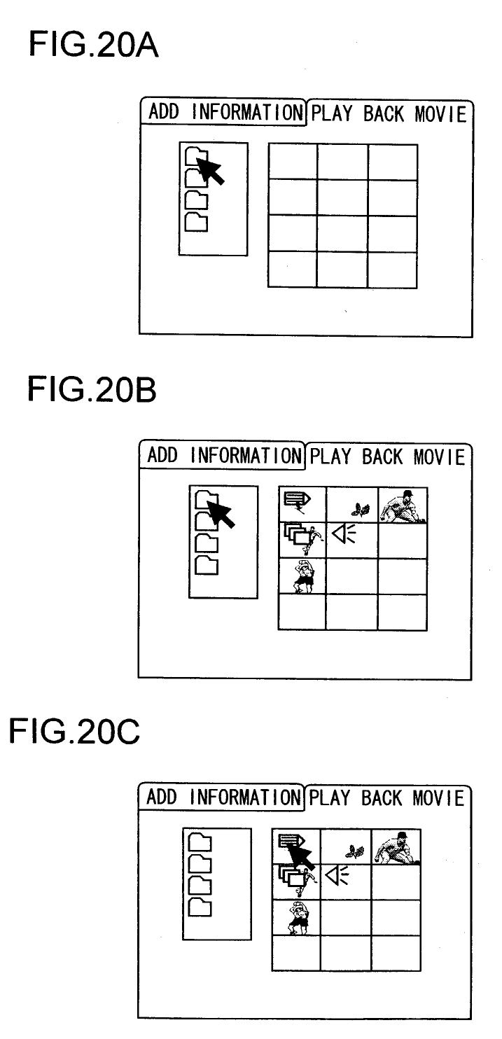

Next, the play-back-movie mode will be described. FIGS. 20A to 20C show examples of the operation guide that are displayed when the play-back-movie mode has just been started. In the operation guide is shown a box in which folders are displayed and a box in which frames, one from each file, are displayed as thumbnail images in an arranged manner. The user first selects a folder (FIG. 20A). When a folder is selected, one frame (with a movie file, the first frame) from each of the files the folder contains is displayed (FIG. 20B).

Here, for a movie file having information added to any of the frames thereof, an icon is displayed that indicates the addition of information and the type of the information added. In the example shown in FIG. 20B, the first image file (the leftmost in the topmost row) has information in the form of text added thereto, the fourth image file (the leftmost in the second row) has information in the form of an image added thereto, and the fifth image file (at the center in the second row) has information in the form of sound added thereto. When a single moving picture has more than one type of information added thereto, all the applicable icons are displayed for the moving picture.

The user selects a desired frame from among the frames displayed in an arranged manner (FIG. 20C). The moving picture containing the selected frame is regarded as the target to be played back. It is to be noted that the frames displayed in an arranged manner include still pictures, which are not selected as a target to be played back in the play-back-movie mode.

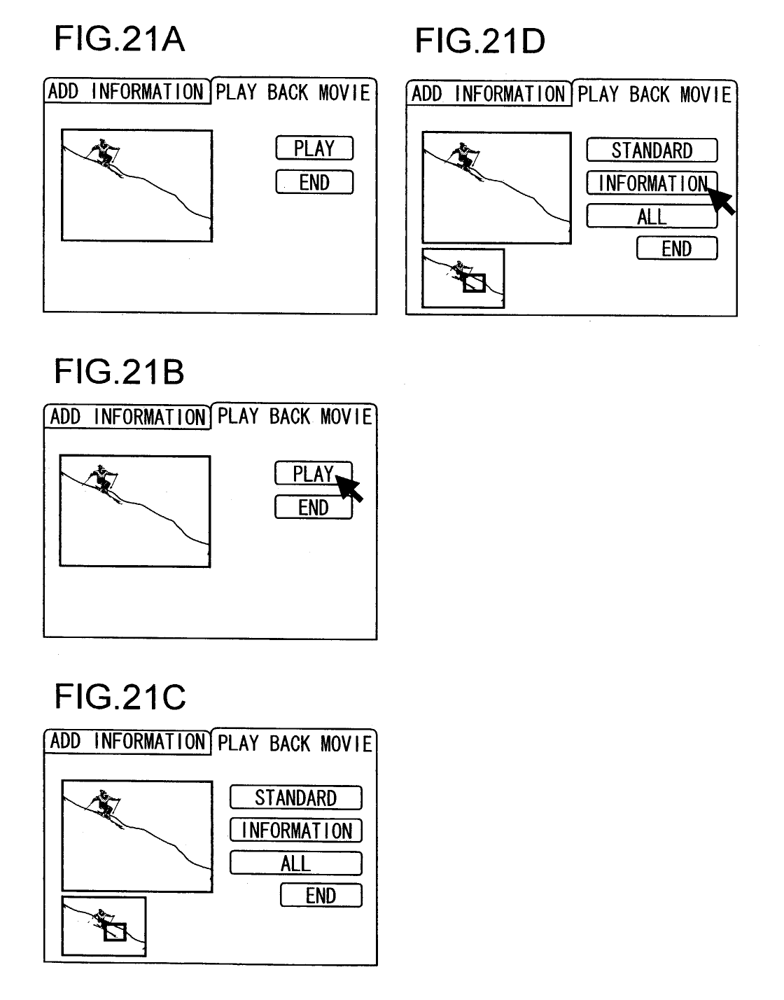

When a moving picture to be played back is selected, its first frame is displayed in its original, i.e., not reduced, size, and, if any of the frames constituting it has information added thereto, the first of the frames having information added thereto is also displayed (see FIG. 21C).

The play-back-movie mode is divided into three submodes. In the first submode, called standard playback mode, a moving picture is played back from its first frame consecutively, and, even when a frame having information added thereto is being displayed, the information is not played back. In the second submode, called information playback mode, only those frames which have information added thereto are played back and the information is played back together. In the third submode, called play-back-all mode, a moving picture is played back from its first frame consecutively up to the frame immediately preceding a frame having information added thereto, and then, while a series of frames having information added thereto is being played back repeatedly, the information is played back together. One of these submodes can be selected after a moving picture to be played back has been selected.

FIGS. 21 A to 21D show examples of the operation guide for letting the user select a submode. In the operation guide are shown the first frame and commands “play” and “end” (FIG. 21A). When “play” is selected (FIG. 21B), commands “standard,” “information,” and “all” are shown, and in addition, if any frame has information added thereto, the first of the frames having information added thereto is shown (FIG. 21C). On the frame having information added thereto, the region set thereon is also shown. The user selects one of “standard,” “information,” and “all” according to in which mode to play back the moving picture (FIG. 21D).

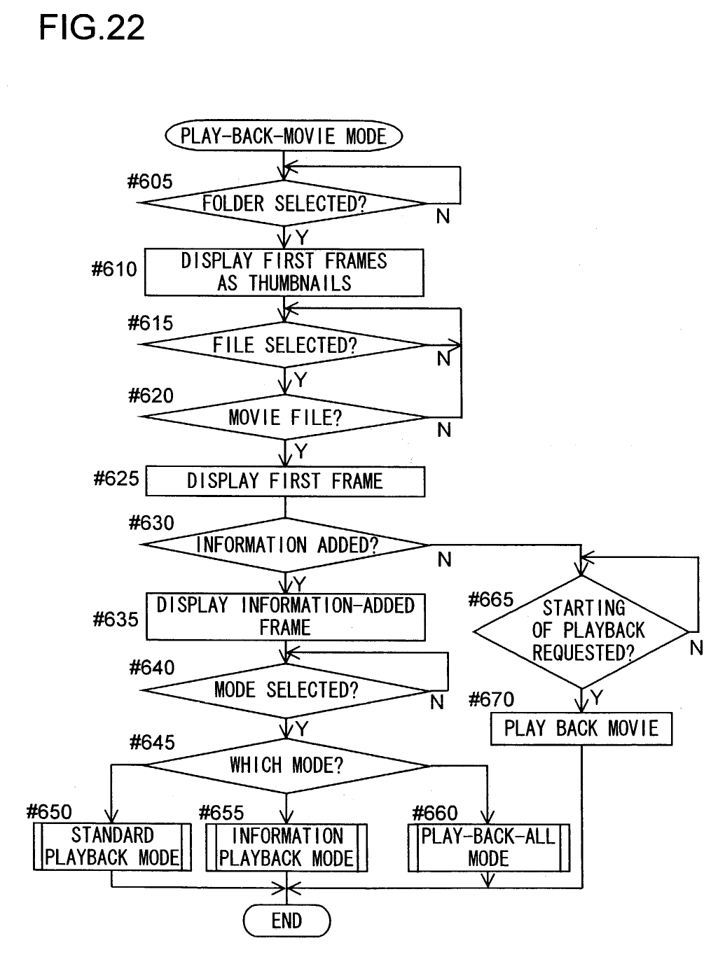

FIG. 22 shows the flow of operations performed by the controller portion 6 in the play-back-movie mode. First, when a folder is selected (step #605), the first frames of all the movie files contained in the selected folder are displayed as thumbnail images in an arranged manner (#610). Next, when a file is selected and its playback is requested (#615), whether or not the selected file is a movie file is checked (#620). If the selected file is not a movie file, the flow returns to step #615, and waits the user to select another.

If the selected file is a movie file, its first frame is displayed (#425), and then, by referring to the header of the file, whether or not any frame has information added thereto is checked (#630). If any frame has information added thereto, the first of the frames having information added thereto is displayed (#635). When a submode is selected (#640), according to the selected submode (#645), the flow proceeds to standard playback mode (#650), information playback mode (#655), or play-back-all mode (#660).

If, in step #630, it is found that no information is added, when playback is requested (#665), the moving picture starts being played back from its first frame (#670).

When a moving picture is played back in standard playback mode or a moving picture having no information added thereto is played back, the image data of all of its frames are played back consecutively while the sound data added to all of its frames is played back as sound. In standard playback mode, even if any frame has information added thereto, that information is not played back.

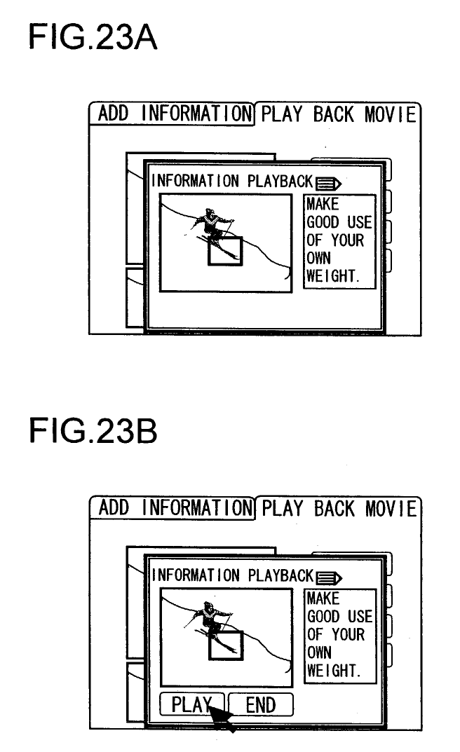

Next, information playback mode will be described. FIGS. 23A and 23B show examples of the operation guide displayed in information playback mode. In information playback mode, first, the first of the frames having information added thereto is played back and displayed together with the region set thereon, and in addition the information added to that frame is also played back by the information reproducer portion 4 that suits the type of the information (FIG. 23A). Thereafter, commands “play” and “end” appear in the operation guide. When the user selects “play” (FIG. 23B), a series of frames having information added thereto which includes the one being displayed are played back together with the information. When the series of frames has been played pack up to the last frame, the playback is halted. In a case where given information is added to only one frame, as soon as the frame and the information are played back together, the playback is halted.

After the playback is halted, when the user selects “play” again, a series of frames having information added thereto which is located after those which have already been played back are played back together with the information. Thereafter, similar operations are repeated until the last frame is reached or “end” is selected.

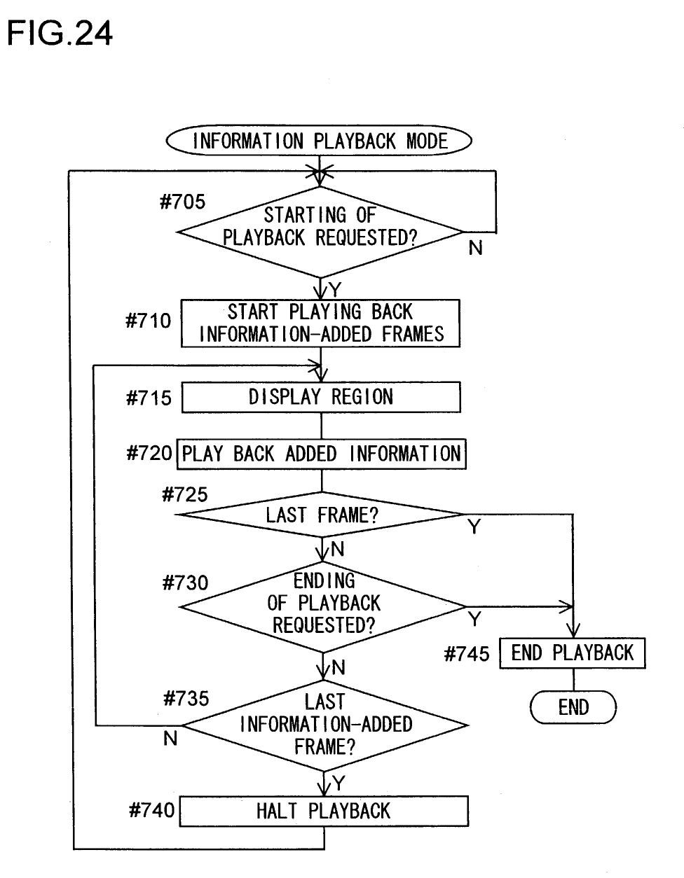

FIG. 24 shows the flow of operations performed by the controller portion 6 in information playback mode. When starting of playback is requested (step #705), the frames having information added thereto start being played back from the first of them (#710). The region on the frame so played back is displayed (#715), and the information added thereto is played back (#720). Next, whether or not the frame being displayed is the last frame of the moving picture is checked (#725), and, if it is not the last frame, whether or not ending of the playback is requested is checked (#730).

If ending of the playback is not requested, whether or not the frame being displayed is the last among a series of frames having information added thereto is checked (#735). If it is not the last of such a series of frames, the flow returns to step #715; if it is the last of such a series of frames, the playback is halted (#740), and the flow then returns to step #705. Back in step #705, when starting of playback is requested, the next series of frames having information added thereto starts being played back.

If, in step #725, it is found that the frame being displayed is the last frame of the moving picture, or if, in step #730, it is found that ending of the playback is requested, the playback is ended (#745), and the flow ends.

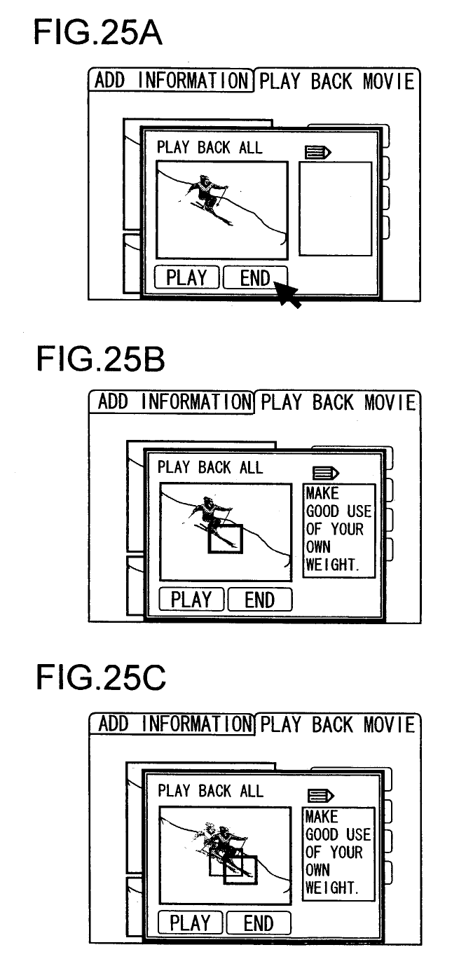

Next, play-back-all mode will be described. FIGS. 25A to 25C show examples of the operation guide displayed in play-back-all mode. In play-back-all mode, a moving picture starts being played back from its first frame (FIG. 25A), and, when a series of frames having information added thereto is reached, those frames are played back repeatedly together with the information (FIG. 25C). In a case where given information is added to only one frame, that frame is played back repeatedly (FIG. 25B). When a frame having information added thereto is played back, the region specified thereon is also displayed.

While a series of frames having information added thereto is being played back repeatedly, when restarting is requested, the succeeding frames start being played back. Restarting is requested by selecting “play.” If the succeeding frames include a series of frames having information added thereto, those frames are played back repeatedly together with the information. Play-back-all mode ends when all the frames have been played back, or ending of the playback is requested by selecting “end” (FIG. 25A).

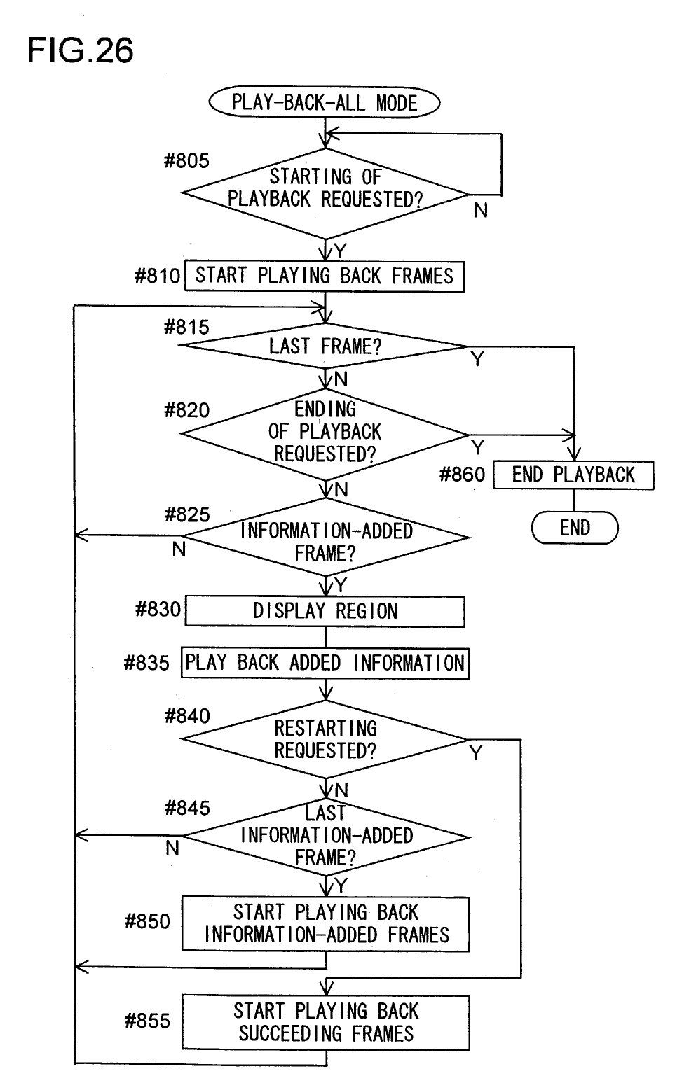

FIG. 26 shows the flow of operations performed by the controller portion 6 in playback-all mode. When starting of playback is requested (step #805), the moving picture starts being played back from its first frame (#810). Then, whether or not the frame being displayed is the last frame of the moving picture is checked (#815). If it is not the last frame, whether or not ending of the playback is requested is checked (#820).

If ending of the playback is not requested, whether or not the frame being displayed has information added thereto is checked (#825), and, if no information is added, the flow returns to step #815. If information is added, the region specified on the frame is displayed (#830), and the added information is played back in a manner that suits the type of the information (#835). Next, whether or not restarting is requested is checked (#840). If no such request is made, whether or not the frame being displayed is the last among a series of frames having information added thereto is checked (#845). If it is not the last of such a series of frames, the flow returns to step #815; if it is the last of a series of frames having information added thereto, the playback of that series of frames is restarted (#850), and the flow returns to step #815.

If, in step #840, it is found that restarting is requested, the frames following the series of frames having information added thereto start being played back from the frame immediately following it (#855), and the flow returns to step #815.

If, in step #815, it is found that the frame being displayed is the last frame of the moving picture, or if, in step #820, it is found that ending of the playback is requested, the playback is ended (#860), and the flow ends.

In information playback mode and play-back-all mode, a command “play previous” may be shown in addition to the command “play” in the operation guide so that, when “play previous” is selected, the series of frames having information added thereto which has been played back immediately before can be played back. This makes it possible to show a series of frames having information added thereto again even after it has already been played back.

Though not described specifically in the add-information mode, selection of a moving picture to which to add information (step #20 in FIG. 6) is achieved by the same procedure shown in FIGS. 20A to 20C which is performed to select a moving picture to be played back. This permits the user to easily recognize whether or not a given moving picture has information already added thereto. The procedure for selecting a moving picture shown in FIGS. 20A to 20C is applicable not only when the moving picture is going to be played back but also, for example, when it is going to be copied, deleted, or transmitted to an external device.

Obviously, many modifications and variations of the present invention are possible in light of the above teachings. It is therefore to be understood that within the scope of the appended claims, the invention may be practiced other than as specifically described.

What is claimed is:

1. An apparatus for processing a moving picture, comprising:
a display for displaying, in an arranged manner, a plurality of frames included in a moving picture;
a selector for selecting, according to a command from a user, part of the displayed frames;
a setter for setting, according to a command from the user, a region on the selected frames;
an input portion for receiving information input by the user; and
a recorder for recording the set region and the input information in association with the selected frames.

2. An apparatus for processing a moving picture as claimed in claim 1,
wherein the display displays frames located at a predetermined time interval from one another.

3. An apparatus for processing a moving picture as claimed in claim 2,
wherein the predetermined time interval is variable.

4. An apparatus for processing a moving picture as claimed in claim 1,
wherein a shape of the region is variable.

5. An apparatus for processing a moving picture as claimed in claim 1,
wherein the selector selects, according to a command from the user, a plurality of frames.

6. An apparatus for processing a moving picture as claimed in claim 5,
wherein the setter sets, based on the region set on the selected frames, a region on all frames located between the selected frames, and
the recorder records the set region and the input information in association with each of the frames.

7. An apparatus for processing a moving picture as claimed in claim 1,
wherein the input portion accepts information in a form of text, sound, or an image.

8. A method for processing a moving picture, comprising the steps of
displaying, in an arranged manner, a plurality of frames included in a moving picture;
selecting, according to a command from a user, part of the displayed frames;
setting, according to a command from the user, a region on the selected frames;
receiving information input by the user; and
recording the set region and the input information in association with the selected frames.

9. A program product having a program recorded therein for executing the steps of:
displaying, in an arranged manner, a plurality of frames included in a moving picture;
selecting, according to a command from a user, part of the displayed frames;
setting, according to a command from the user, a region on the selected frames;
receiving information input by the user; and
recording the set region and the input information in association with the selected frames.

10. An apparatus for processing a moving picture, comprising:
a memory for recording a plurality of moving pictures including a moving picture having information added to part of frames thereof,
a first display for displaying part of frames of the moving pictures recorded in the memory;
a discriminator for checking whether or not a moving picture that includes any of the frames displayed by the first display includes a frame to which information is added, and
a second display for displaying, when a moving picture that includes any of the frames displayed by the first display includes a frame to which information is added, an indicator with respect to that moving picture to indicate that the moving picture includes a frame to which information is added.

11. An apparatus for processing a moving picture as claimed in claim 10,
wherein the first display displays, in an arranged manner, a plurality of frames included in different moving pictures.

12. An apparatus for processing a moving picture as claimed in claim 10,
wherein information added to a frame is in a form of text, sound, or an image.

13. An apparatus for processing a moving picture as claimed in claim 12,
wherein the second display displays the indicator in one of different manners according to type of the information.

14. An apparatus for processing a moving picture as claimed in claim 10, further comprising:
a third display for displaying, when any of the frames displayed by the first display has information added in a particular region thereon, that frame anew in a manner that indicates the region.

15. A method for processing a moving picture, comprising the steps of:
displaying part of frames included in a plurality of moving pictures;
checking whether or not a moving picture that includes any of the displayed frames includes a frame to which information is added; and
displaying, when a moving picture that includes any of the displayed frames includes a frame to which information is added, an indicator with respect to that moving picture to indicate that the moving picture includes a frame to which information is added.

16. A program product having a program recorded therein for executing the steps of:
displaying part of frames included in a plurality of moving pictures;
checking whether or not a moving picture that includes any of the displayed frames includes a frame to which information is added; and
displaying, when a moving picture that includes any of the displayed frames includes a frame to which information is added, an indicator with respect to that moving picture to indicate that the moving picture includes a frame to which information is added.

17. An apparatus for processing a moving picture, comprising:
a memory for recording a moving picture having information added to part of frames thereof;
an image reproducer for playing back the moving picture recorded in the memory;
an information reproducer for playing back the information added to part of the frames of the moving picture recorded in the memory;
a selector for selecting, according to a command from a user, among a first playback mode in which, when the frames having the information added thereto are played back, the information is not played back, a second playback mode in which only the frames having the information added thereto are played back together with the information, and a third playback mode in which, when the frames having the information added thereto are played back, the information is played back; and
a controller for controlling playback of the moving picture by the image reproducer and playback of the information by the information reproducer according to the playback mode selected by the selector.

18. An apparatus for processing a moving picture as claimed in claim 17,
wherein information added to a frame is in a form of text, sound, or an image.

19. An apparatus for processing a moving picture as claimed in claim 17,
wherein, in the second and third playback modes, the image reproducer, if a frame to be played back has information added in a particular region thereon, displays the region.

20. A method for processing a moving picture, comprising the steps of:
recording a moving picture having information added to part of frames thereof;
selecting among a first playback mode in which, when the frames having the information added thereto are played back, the information is not played back, a second playback mode in which only the frames having the information added thereto are played back together with the information, and a third playback mode in which, when the frames having the information added thereto are played back, the information is played back; and
playing back the moving picture and the information according to the selected playback mode.

21. A program product having a program recorded therein for executing the steps of:
recording a moving picture having information added to part of frames thereof;
selecting among a first playback mode in which, when the frames having the information added thereto are played back, the information is not played back, a second playback mode in which only the frames having the information added thereto are played back together with the information, and a third playback mode in which, when the frames having the information added thereto are played back, the information is played back; and
playing back the moving picture and the information according to the selected playback mode.
